(19) United States
(12) Patent Application Publication
(10) Pub. No.: US 2025/0309963 A1
(43) Pub. Date: Oct. 2, 2025

(54) PRECODING FOR JOINT TRANSMISSION IN DISTRIBUTED MIMO WITH EXPLICIT AND IMPLICIT SIGNALING

(71) Applicant: Samsung Electronics Co., Ltd., Suwon-si (KR)

(72) Inventors: Rui Huang, Vancouver (CA); R A Nadisanka Perera Rupasinghe, McKinney, TX (US)

(21) Appl. No.: 19/066,083

(22) Filed: Feb. 27, 2025

Related U.S. Application Data
(60) Provisional application No. 63/569,870, filed on Mar. 26, 2024.

(51) Int. Cl. H04B 7/06

(52) U.S. Cl. CPC H04B 7/0626; H04B 7/0639

(57) ABSTRACT

A method of operating a BS includes receiving, from a first UE in a distributed MIMO system, an explicit CSI signaling, receiving, from a second UE in the distributed MIMO system, an implicit CSI signaling, and configuring, based on at least one correlation between the explicit CSI signaling and the implicit CSI signaling, at least one precoder for a transmission to the first UE. The at least one precoder for transmission to the first UE is configured to mitigate interference between the first UE and the second UE, and preserve a target signal power receivable by at least one of the first UE and the second UE. The method also includes determining, based on the explicit CSI signaling, the implicit CSI signaling, and at least one specified condition whether to update at least one previously determined precoder for transmission to the second UE.

### CROSS-REFERENCE TO RELATED APPLICATION(S) AND CLAIM OF PRIORITY

This application claims priority under 35 U.S.C. § 119 (e) to U.S. Provisional Patent Application No. 63/569,870 filed on Mar. 26, 2024. The above-identified provisional patent application is hereby incorporated by reference in its entirety.

### TECHNICAL FIELD

This disclosure relates generally to wireless networks. More specifically, this disclosure relates to precoding for joint transmission (JT) in distributed multi-input multi-output (MIMO) with explicit and implicit signaling.

### BACKGROUND

For a cellular system operating in a low carrier frequency in general, for example a sub-1 GHz frequency range (e.g., less than 1 GHZ), supporting a large number of channel state information-reference signal (CSI-RS) antenna ports (e.g., 32) or many antenna elements at a single location or remote radio head (RRH) is challenging due to a larger antenna form factor size needed for the carrier frequency wavelength compared to a system operating at a higher frequency such as 2 GHz or 4 GHz. At such low frequencies, the maximum number of CSI-RS antenna ports that can be co-located at a site (or RRH) can be limited, for example to 8. This limits the spectral efficiency of such systems. In particular, the MU-MIMO spatial multiplexing gains offered due to the large number of CSI-RS antenna ports (such as 32) can't be achieved due to the antenna form factor limitation. One way to operate a system with large number of CSI-RS antenna ports at a low carrier frequency is to distribute the physical antenna ports to different panels/RRHs, which can be possibly non-collocated. The multiple sites or panels/RRHs can still be connected to a single (common) base unit forming a single antenna system, hence the signal transmitted/received via multiple distributed RRHs can still be processed at a centralized location.

### SUMMARY

This disclosure provides apparatuses and methods for a precoding design for JT in distributed MIMO with explicit and implicit signaling.

In one embodiment, a base station (BS) is provided. The BS includes a transceiver configured to receive, from a first user equipment (UE) in a distributed multi-input multi-output (MIMO) system, an explicit channel state information (CSI) signaling, and receive, from a second UE in the distributed MIMO system, an implicit CSI signaling. The BS also includes a processor operably coupled to the transceiver. The processor is configured to configure, based on at least one correlation between the explicit CSI signaling and the implicit CSI signaling, at least one precoder for a transmission to the first UE. The at least one precoder for transmission to the first UE is configured to mitigate interference between the first UE and the second UE, and preserve a target signal power receivable by at least one of the first UE and the second UE. The processor is also configured to determine, based on the explicit CSI signaling, the implicit CSI signaling, and at least one specified condition whether to update at least one previously determined precoder for transmission to the second UE.

In another embodiment, a method of operating a BS is provided. The method includes receiving, from a first UE in a distributed MIMO system, an explicit CSI signaling, receiving, from a second UE in the distributed MIMO system, an implicit CSI signaling, and configuring, based on at least one correlation between the explicit CSI signaling and the implicit CSI signaling, at least one precoder for a transmission to the first UE. The at least one precoder for transmission to the first UE is configured to mitigate interference between the first UE and the second UE, and preserve a target signal power receivable by at least one of the first UE and the second UE. The method also includes determining, based on the explicit CSI signaling, the implicit CSI signaling, and at least one specified condition whether to update at least one previously determined precoder for transmission to the second UE.

In yet another embodiment, a non-transitory computer readable medium embodying a computer program is provided. The computer program includes program code that, when executed by a processor of a device, causes the device to receive, from a first UE in a distributed MIMO system, an explicit CSI signaling, receive, from a second UE in the distributed MIMO system, an implicit CSI signaling, and configure, based on at least one correlation between the explicit CSI signaling and the implicit CSI signaling, at least one precoder for a transmission to the first UE. The at least one precoder for transmission to the first UE is configured to mitigate interference between the first UE and the second UE, and preserve a target signal power receivable by at least one of the first UE and the second UE. The computer program also includes program code that, when executed by the processor of the device, causes the device to determine, based on the explicit CSI signaling, the implicit CSI signaling, and at least one specified condition whether to update at least one previously determined precoder for transmission to the second UE.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The following documents and standards descriptions are hereby incorporated by reference into the present disclosure as if fully set forth herein:
[1] 3GPP TS 36.211 v16.4.0, “E-UTRA, Physical channels and modulation.”
[2] 3GPP TS 36.212 v16.4.0, “E-UTRA, Multiplexing and Channel coding.”
[3] 3GPP TS 36.213 v16.4.0, “E-UTRA, Physical Layer Procedures.”
[4] 3GPP TS 36.321 v16.3.0, “E-UTRA, Medium Access Control (MAC) protocol specification.”
[5] 3GPP TS 36.331 v16.3.0, “E-UTRA, Radio Resource Control (RRC) Protocol Specification.”
[6] 3GPP TS 38.211 v16.4.0, “NR, Physical channels and modulation.”
[7] 3GPP TS 38.212 v16.4.0, “NR, Multiplexing and Channel coding.”
[8] 3GPP TS 38.213 v16.4.0, “NR, Physical Layer Procedures for Control.”
[9] 3GPP TS 38.214 v16.4.0, “NR, Physical Layer Procedures for Data.”
[10] 3GPP TS 38.215 v16.4.0, “NR, Physical Layer Measurements.”
[11] 3GPP TS 38.321 v16.3.0, “NR, Medium Access Control (MAC) protocol specification.”
[12] 3GPP TS 38.331 v16.3.1, “NR, Radio Resource Control (RRC) Protocol Specification.”

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example of CSI-RS port mapping according to embodiments of the present disclosure;

FIG. 5 illustrates an example of distributed MIMO according to embodiments of the present disclosure;

FIG. 6 illustrates another example of distributed MIMO according to embodiments of the present disclosure;

FIGS. 7A-7B illustrate examples of joint transmission according to embodiments of the present disclosure;

FIG. 8 illustrates an example of cell collaboration for joint transmission according to embodiments of the present disclosure;

FIG. 9 illustrates an example method for precoder determination for joint transmission according to embodiments of the present disclosure; and

FIG. 10 illustrates an example method for operating a base station according to embodiments of the present disclosure.

### DETAILED DESCRIPTION

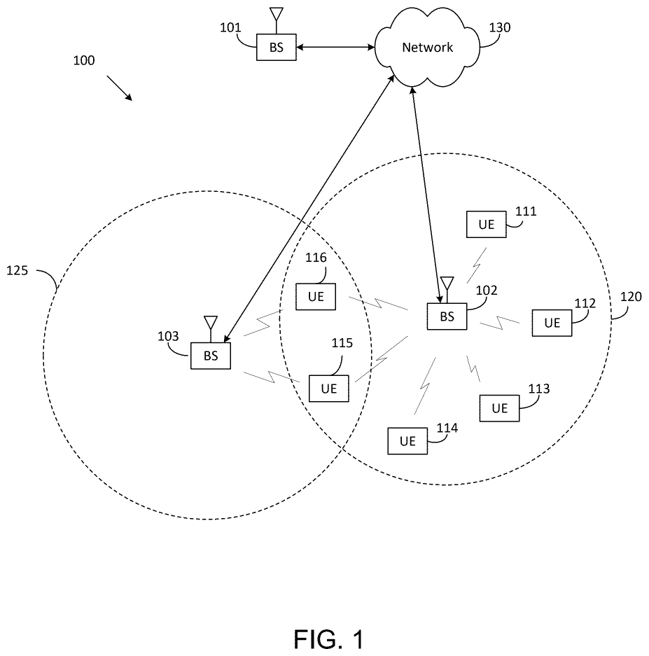

FIGS. 1 through 10, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a precoding design for JT in distributed MIMO with explicit and implicit signaling. In certain embodiments, one or more of the gNBs 101-103 includes circuitry, programing, or a combination thereof, to support a precoding design for JT in distributed MIMO with explicit and implicit signaling in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

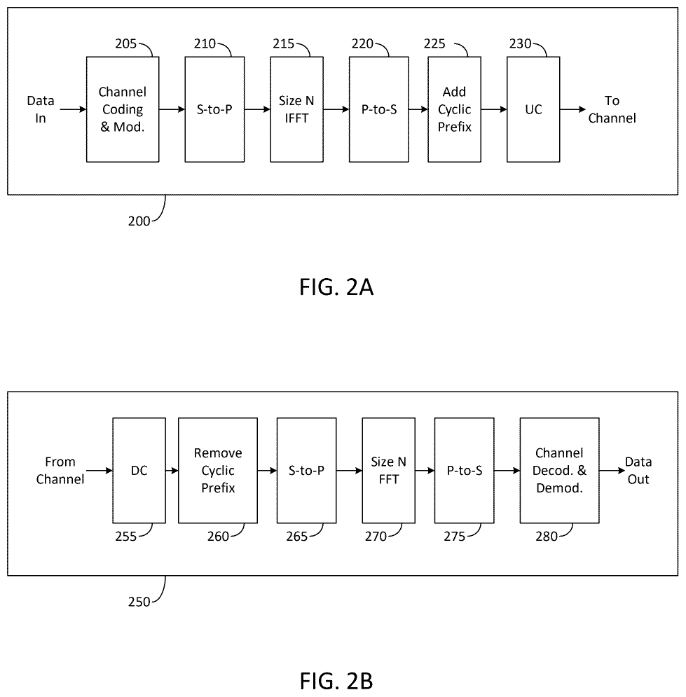

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support a precoding design for JT in distributed MIMO with explicit and implicit signaling as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

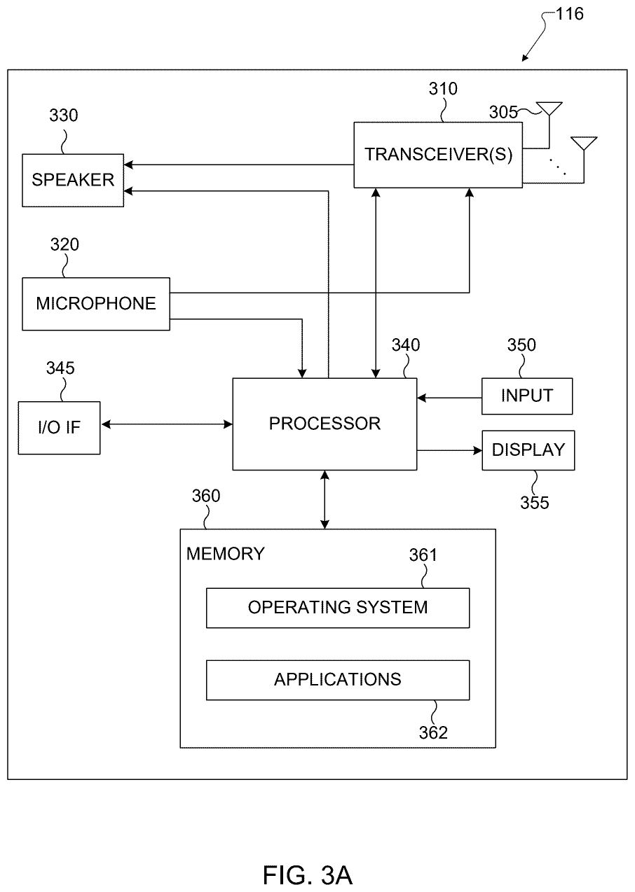

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for a precoding design for JT in distributed MIMO with explicit and implicit signaling as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support a precoding design for JT in distributed MIMO with explicit and implicit signaling as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

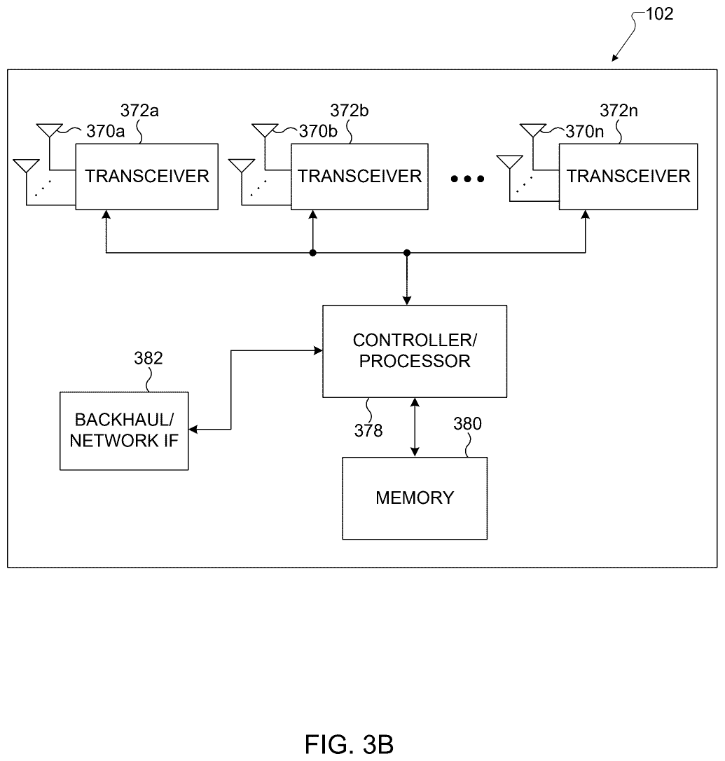

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports (which can correspond to the number of digitally precoded ports) tends to be limited due to hardware constraints (such as the feasibility to install a large number of ADCs/DACs at mmWave frequencies) as illustrated in FIG. 4.

FIG. 4 illustrates an example of CSI-RS port mapping 400 according to embodiments of the present disclosure. The embodiment of CSI-RS port mapping of FIG. 4 is for illustration only. Different embodiments of CSI-RS port mapping could be used without departing from the scope of this disclosure.

In the example of FIG. 4, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles (420) by varying the phase shifter bank across symbols or subframes. The number of sub-arrays (equal to the number of RF chains) is the same as the number of CSI-RS ports NCSI-PORT. A digital beamforming unit 410 performs a linear combination across NCSI-PORT analog beams to further increase precoding gain. While analog beams are wideband (hence not frequency-selective), digital precoding can be varied across frequency sub-bands or resource blocks (RBs). Receiver operation can be conceived analogously.

Although FIG. 4 illustrates one example of CSI-RS port mapping 400, various changes may be made to FIG. 4. For example, various changes to the number of beams could be made, the size of the antenna array, etc. according to particular needs.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz (also termed the FR4). In this case, the system can employ only analog beams. Due to the O2 absorption loss around 60 GHz frequency (˜10 dB additional loss @100 m distance), larger numbers of and sharper analog beams (hence larger number of radiators in the array) are used to compensate for the additional path loss.

At lower frequency bands such as FR1 or particularly the sub-1 GHz band, on the other hand, the number of antenna elements cannot be increased in a given form factor due to the large wavelength if a critical distance (≥λ/2) between two adjacent antenna elements is maintained in deployment scenarios. As an example, for the case of the wavelength size (λ) of the center frequency 600 MHz (which is 50 cm), 4 m is required for a uniform-linear-array (ULA) antenna panel of 16 antenna elements with the half-wavelength distance between two adjacent antenna elements. Considering a plurality of antenna elements is mapped to one digital port in practical cases, the required size for antenna panels at a gNB to support a large number of antenna ports, e.g., 32 CSI-RS ports, becomes very large in such low frequency bands, and it leads to the difficulty of deploying 2-D antenna arrays within the size of a conventional form factor. This can result in a limited number of physical antenna elements and, subsequently CSI-RS ports, that can be supported at a single site and limits the spectral efficiency of such systems.

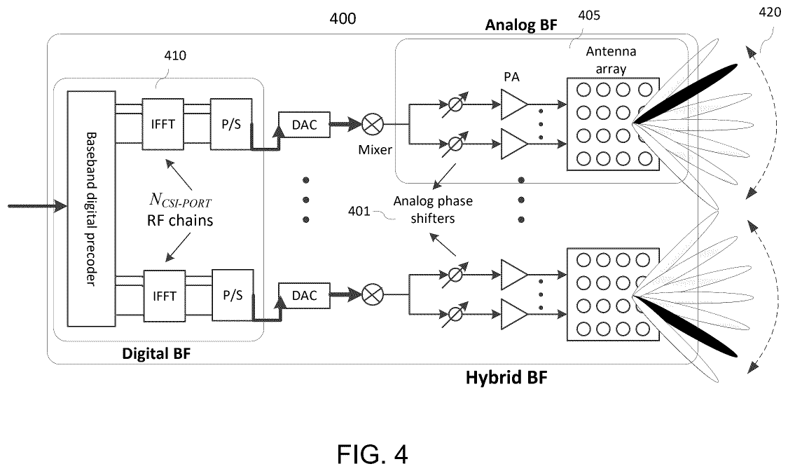

One possible approach to resolve the issue is to form multiple antenna panels (e.g., antenna modules, RRHs) with a small number of antenna ports instead of integrating all of the antenna ports in a single panel (or at a single site) and to distribute the multiple panels in multiple locations/sites (or RRHs), as illustrated in FIG. 5.

FIG. 5 illustrates an example of distributed MIMO 500 according to embodiments of the present disclosure. In the example of FIG. 5, distributed MIMO 500 is formed from multiple antenna panels, such as antenna modules or remote radio heads (RRHs), with a small number of antenna ports instead of integrating all the antenna ports in a single panel or at a single site and distributing the multiple panels in multiple locations/sites or RRHs. The example of FIG. 5 may be implemented by a BS. For instance, the example of distributed MIMO 500 may be implemented by one or more BSs such as BS 102. The example of distributed MIMO 500 is for illustration only and other embodiments can be used without departing from the scope of the present disclosure.

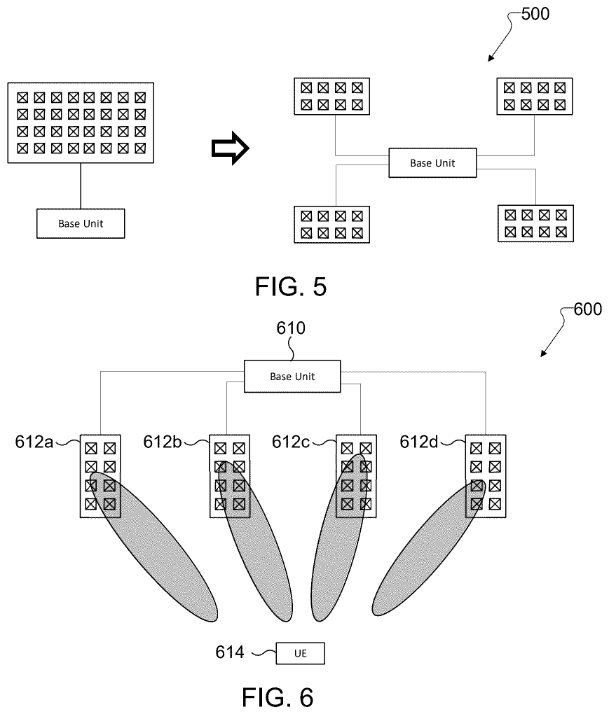

The multiple antenna panels at multiple locations can still be connected to a single base unit, and thus the signal transmitted/received via multiple distributed panels can be processed in a centralized manner through the single base unit, as illustrated in FIG. 6. In another embodiment, it is possible that multiple distributed antenna panels are connected to more than one base unit, which communicate with each other and jointly support the single antenna system.

FIG. 6 illustrates another example of distributed MIMO 600 according to embodiments of the present disclosure. In the example of FIG. 6, multiple antenna locations 612a-612d are connected to a single base unit 610. The base unit 610 may process signals transmitted and received via antenna locations 612a-612d in a centralized manner. For example, base unit 610 may process signals transmitted and received to UE 614. The example of FIG. 6 may be implemented by a BS. For example, the distributed MIMO 600 may be implemented by one or more BSs such as BS 102. The example of distributed MIMO 600 is for illustration only and other embodiments can be used without departing from the scope of the present disclosure.

In time division duplex (TDD) systems, a common approach to acquire DL channel state information is to exploit UL channel estimation through receiving UL reference signals (RSs) (e.g., sounding reference signal [SRS]) sent from the UE. By using the channel reciprocity in TDD systems, the UL channel estimation itself can be used to infer DL channels. This favorable feature enables the network to reduce the training overhead significantly. However, due to the RF impairment at the transmitter and the receiver, directly using the UL channels for DL channels is not accurate and it requires a calibration process (periodically) among receive and transmit antenna ports of the RF network at the network. In general, the network has an on-board calibration mechanism in its own RF network to calibrate its antenna panels having a plurality of receiver/transmitter antenna ports, to enable DL/UL channel reciprocity in channel acquisition. The on-board calibration mechanism can be performed via small-power reference signal (RS) transmission and reception from/to the RF antenna network of the network, and thus calibration can be done according to the network's implementation in a confined manner (i.e., that does not interfere with other entities). However, it becomes difficult to perform the on-board calibration in distributed MIMO systems due to the distribution of the panels/RRHs over a wide region, and thus over-the-air (OTA) signaling mechanisms are utilized to calibrate receive/transmit antenna ports among multiple RRHs/panels far away in distributed MIMO.

Precoder design is an important issue for distributed MIMO for enhancing received signal power and mitigating interference, especially when multiple UEs are scheduled together to share the same time, frequency, and power resources. In order to design the precoding for each scheduled user, explicit or implicit signaling is used to obtain information about the UL/DL channel state information (CSI) between the antenna ports of transmitters and receivers. With such information about the UL/DL channels, the precoder for each UE can be properly derived to potentially maximize the signal-to-noise-plus-interference ratio (SINR) of the received signal, thereby achieving a higher throughput. However, a precoding design to achieve diversity gain in distributed MIMO may not always be available. In particular, a helping TRP of a UE served with joint transmission (referred to as a JT UE) may have traffic from time-to-time to transmit to a different UE for which the helping TRP is a serving TRP. When there is traffic at the helping TRP for the different UE, the helping TRP should determine a precoder to minimize the interference level at the JT UE. Otherwise, the JT UE will suffer not only from the loss of diversity gain but also from additional interference due to the helping TRP's transmission to its own UE.

For example, in main cell JT, co-ordination handshaking between a serving and helping cells for JT takes place approximately every 0.5 seconds. After a successful handshake, the serving cell assumes JT is available uninterruptedly for a JT UE. However, as noted above, a helping cell may need to take care of its own traffic from time-to-time. This may result in some transmission time intervals (TTIs) with no JT from the helping cell. In these circumstances (referred to as a JT failure event), the helping cell becomes an interferer, and the JT failure event may result in a packet drop, impacting the overall link adaptation process. This may result in a reduced rank indicator (RI)/modulation coding scheme (MCS) for the JT UE.

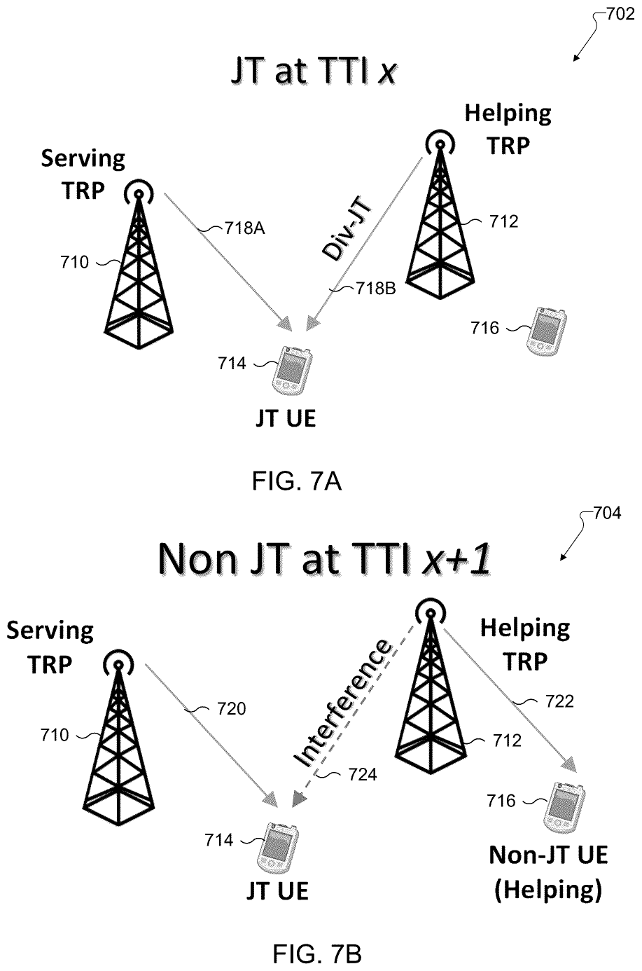

FIGS. 7A-7B illustrate examples 702 and 704 of joint transmission according to embodiments of the present disclosure. The embodiment of joint transmission of FIGS. 7A-7B is for illustration only. Different embodiments of joint transmission could be used without departing from the scope of this disclosure.

In example 702 shown in FIG. 7A, a JT toward a JT UE 714 is performed at a TTI x. At TTI x, a BS 710 is acting as a serving TRP and a BS 712 is acting as a helping TRP for the JT UE 714. During TTI x, BS 710 transmits a signal 718A and BS 712 transmits a signal 718B to JT UE 714 according to divided-JT (Div-JT) operation. BS 712 does not transmit any signals to non-JT UE 716, which is served by BS 712, at TTI x.

In example 704 shown in FIG. 7B, various non-joint transmissions are performed toward JT UE 714 and non-JT UE 716 at a TTI x+1. In example 704, BS 710 presumes that BS 712 is available to perform a JT toward JT UE 714, and BS 710 transmits a signal 720 toward JT UE 714. However, BS 712 has traffic for non-JT UE 716, and BS 712 transmits a signal 722 toward non-JT UE 716. This results in interference 724 interfering with signal 720.

Although FIGS. 7A-7B illustrate examples 702 and 704 of joint transmission, various changes may be made to FIGS. 7A-7B. For example, the joint transmission could include additional TRPs, occur at different TTIs, etc. according to particular needs.

In distributed MIMO systems, due to different configurations of different base stations and UEs, different forms/formats of reference signals may be used to obtain the UL/DL CSI. In particular, some base stations and UEs may use explicit signaling to obtain the CSI, while some other base stations and UEs may use implicit signaling. Moreover, in distributed MIMO, different UEs may be assigned with different priorities regarding the data transmission intended for the particular UEs. In light of this, the precoding design in distributed MIMO should accommodate different and diverse configurations of explicit and implicit signaling for CSI acquisition. Without properly designing a precoding method to accommodate the mixture of explicit and implicit signaling, it is difficult to mitigate the interference between the UEs, and such uncontrolled interference may lead to significant degradation in throughput and reliability experiences by all the UEs in distributed MIMO systems.

Various embodiments of the present disclosure provide mechanisms to mitigate the interference between multiple UEs in distributed MIMO systems and improve their throughput. For example, various embodiments of the present disclosure provide precoding methods for distributed MIMO systems where different base stations and UEs are using different formats of explicit and implicit signaling to obtain CSI information. In some embodiments, explicit signaling may include reference signals that directly reflect the values of the entries in the channel matrix/vector, for example, sounding reference signaling (SRS). In some embodiments, implicit signaling may indicate the properties of the CSI and the preferred precoders, instead of directly reflecting the values of the entries in the channel matrix/vector. Examples of implicit signaling may include Precoding Matrix Indicator (PMI). However, it should be understood that SRS is merely an example for explicit signaling, and PMI reports are merely an example for implicit signaling. Various embodiments of the present disclosure can also be applied to other explicit and implicit signaling, such as other reference signals including CSI-RS and demodulation reference signals (DMRS).

Although low-band TDD systems are exemplified for motivation purposes, embodiments of the present disclosure can be applied to any frequency band in FR1 and/or frequency division duplex (FDD) systems.

All the following components and embodiments are applicable for UL transmission with cyclic prefix OFDM (CP-OFDM) waveforms as well as DFT-spread OFDM (DFT-SOFDM) and single-carrier FDMA (SC-FDMA) waveforms. Furthermore, all the following components and embodiments are applicable for UL transmission when the scheduling unit in time is either one subframe (which can comprise one or multiple slots) or one slot.

For ease of explanation, distributed MIMO systems as referred to herein are considered to comprise two types of UEs. The first type is Type I UEs, which are UEs for which explicit signals are used to collect CSI. The second type is Type II UEs, which are UEs for which implicit signals are used to collect CSI.

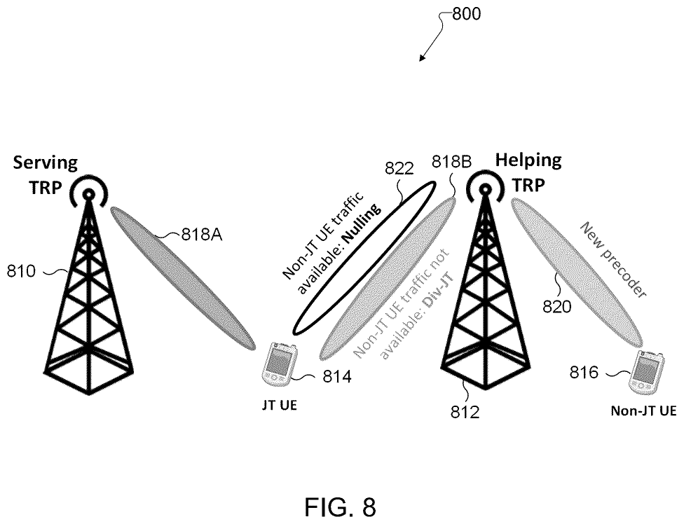

FIG. 8 illustrates an example 800 of cell collaboration for joint transmission according to embodiments of the present disclosure. The embodiment of cell collaboration for joint transmission of FIG. 8 is for illustration only. Different embodiments of cell collaboration for joint transmission could be used without departing from the scope of this disclosure.

In example 800, a distributed MIMO system includes a first BS 810 and a second BS 812. BS 810 is acting as a serving TRP and BS 812 is acting as a helping TRP for a JT UE 814. JT UE 814 is a Type I UE (i.e., JT UE 814 is a UE for which explicit signals are used to collect CSI). BS 812 is also acting as a serving cell for non-JT UE 816. Non-JT UE 816 is a Type II UE (i.e., JT UE 814 is a UE for which implicit signals are used to collect CSI). In example 800, Type I UEs are considered to be prioritized over Type II UEs where the interference from Type II UEs to Type I UEs is mitigated such that the Type I UEs can experience higher SINRs. However, prioritization can be presented in many forms, and various embodiments of the present disclosure can utilize other forms of prioritization.

In example 800, for any particular TTI, BS 810 presumes that BS 812 is available to perform a JT toward JT UE 814, and BS 810 may transmit a signal 818A based on a precoder W_{1,1} toward JT UE 814. For a TTI where BS 812 does not have traffic for non-JT UE 816, BS 812 transmits a signal 818B based on a precoder W_{2,1} to JT UE 814 according to Div-JT operation.

For a TTI where BS 812 has traffic for non-JT UE 816, BS 812 transmits a signal 820 to non-JT UE 816 based on a precoder W_{2,2}. The precoder W_{2,2} is designed as described herein to maximize the SINR of JT UE 814 and maximize the SINR of non-JT UE 816 while minimizing leakage towards JT UE 814. This results in interference nulling 822 for signal 818A toward JT UE 814.

While FIG. 8 illustrates a use case comprising one Type I UE (i.e., JT UE 814) and one Type II UE (i.e., non-JT UE 816), where the Type I UE is being served by two TRPs (i.e., BS 810 and BS 812) while the Type II UE is served by only one TRP (i.e., BS 812), this is for ease of explanation, and various embodiments of the present disclosure can be applied to use cases with more than one UE of each type, and one or more TRPs serving one or more UEs.

Although FIG. 8 illustrates one example 800 of cell collaboration for joint transmission, various changes may be made to FIG. 8. For example, cell collaboration for joint transmission could include additional different TRPs, include interference nulling for transmissions to additional UEs, etc. according to particular needs.

In example 800, it is presumed that SRS from JT UE 814 is available at both BS 810 and BS 812, and that only reported PMI from non-JT UE 816 is available at BS 812. The SRS-estimated channel between JT UE 814 and BS 810 and BS 812 is denoted herein as H_{1,1} and H_{2,1}, respectively. The reported PMI by non-JT UE 816 to BS 812 is denoted herein as W_{CB}.

In some embodiments the precoders W_{1,1}, W_{2,1} for JT UE 814 at BS 810 and BS 812 and precoder W_{2,2} for non-JT UE 816 at BS 814 may be designed according to a two-step procedure as follows.

In the first step of the procedure, the SINR γ₁ of JT UE 814 is maximized according to

$${γ}_{1} = \frac{{\vert {FH}_{1 , 1} {W}_{1 , 1} + {FH}_{2 , 1} {W}_{2 , 1} \vert}^{2}}{{\vert {FH}_{2 , 1} {W}_{2 , 2} \vert}^{2} + {‖ F ‖}_{2}^{2} {σ}^{2}} , \qquad ( 1 )$$

where F denotes the receive beamforming employed at JT UE 814.

In the first step, interference cancellation techniques are applied to the interference from non-JT UE 816 (i.e., |FH_{2,1}W_{2,2}|²), such that the interference is reduced close to zero (i.e., |FH_{2,1}W_{2,2}|²→0). This is achieved by utilizing a properly designed precoder W_{2,2}. Details for designing a precoder W_{2,2} to satisfy such interference constraints are described later herein.

Given that the interference from non-JT UE 816 can be mitigated, in some embodiments the precoders W_{1,1}, W_{2,1} can be derived based on the SRS-estimated channels H_{1,1} and H_{2,1} to maximize the SINR 11. In some embodiments, the precoders W_{1,1}, W_{2,1} can be derived independently at BS 810 and BS 812, in a distributed manner. For example, in some embodiments the precoders W_{1,1}, W_{2,1} can be derived as W_{1,1}(n)=(H_{1,1}(n)^{H}H_{1,1}(n))⁻¹H_{1,1}(n)^{H}, where n indicates the channel at the n-th resource block (RB), and W_{2,1}(n)=(H_{2,1}(n)^{H}H_{2,1}(n))⁻¹H_{2,1}(n)^{H}. In some embodiments, the precoders W_{1,1}, W_{2,1} can be derived jointly based on the joint channel of H_{1,1} and H_{2,1} (i.e., H=[H_{1,1}; H_{2,1}]). For example, in some embodiments the precoders W_{1,1}, W_{2,1} can be derived as [W_{1,1}(n), W_{2,1}(n)]=(H(n)^{H}H(n))⁻¹H(n)^{H}.

In the second step of the procedure, the precoder W_{2,2} is designed to maximize the SINR (e.g., by improving the beamforming gain) of non-JT UE 816, with a constraint on interference leakage toward JT UE 814 (to limit the interference towards JT UE 814). In some embodiments, a precoder determination problem for non-JT UE 816 can be formulated as the following signal-to-leakage-and-noise (SLNR) ratio of non-JT UE 816 as

$${W}_{2 , 2} = arg {max}_{p} \frac{Tr \{ {{P}^{H} ( {\tilde{H}}_{2 , 2} )}^{H} {\tilde{H}}_{2 , 2} P \}}{{\sum }_{j = 1}^{{N}_{R B}} Tr \{ {{P}^{H} ( {H}_{2 , 1} ( j ) )}^{H} {H}_{2 , 1} ( j ) P \}} . \qquad ( 2 )$$

Note that, in equation (2), \tilde{H}_{2,2} is used to denote the CSI of the channel between BS 812 and non-JT UE 816, which is NOT available at BS 812. This is because in order to obtain the specific matrix \tilde{H}_{2,2}, explicit signaling is needed between BS 812 and non-JT UE 816, which is not available in the distributed MIMO system shown in FIG. 8. Lacking the direct estimation on \tilde{H}_{2,2} poses a challenge on deriving the optimal precoder in equation (2).

In some embodiments, the implicit signaling available at BS 812 for non-JT UE 816 is leveraged to derive the optimal precoder for W_{2,2} without relying on explicit signaling. In some embodiments, the PMI reported by non-JT UE 816 (i.e., W_{CB}) is used to approximate the CSI of the channel between BS 812 and non-JT UE 816 as

$${\tilde{H}}_{2 , 2} = {W}_{CB}^{H} . \qquad ( 3 )$$

Equation (3) presumes that when non-JT UE 816 reported the PMI, non-JT UE 816 intended to select the PMI that maximized non-JT UE 816's SINR, which may be well-aligned with the channel \tilde{H}_{2,2}. Theoretically, the maximum beamforming gain |\tilde{H}_{2,2}W_{2,2}|² can be achieved when W_{2,2}= [symbol] _{2,2}.

In some embodiments, with the approximation of \tilde{H}_{2,2} in equation (3), the precoder W_{2,2} may be derived, depending on different configurations and requirements, based on one of a spatial covariance matrix and null space projection, a resource block (RB)-level SRS channel, or subspace precoding as described herein.

In some embodiments, a wideband precoder W_{2,2} cand be determined using a spatial covariance matrix and null space projection. In some embodiments, the wideband precoder W_{2,2} can be applied to each RB. In in these embodiments, the spatial covariance matrix of H_{2,1} can be determined based on the following equation

$${R}_{2 , 1} = \frac{1}{{N}_{R B}} {\sum }_{j = 1}^{{N}_{R B}} {H}_{2 , 1}^{H} ( j ) {H}_{2 , 1} ( j ) . \qquad ( 4 )$$

Presuming the leakage constraint, |FH_{2,1}W_{2,2}|²→0 is satisfied, then, the eigen value decomposition of R₂ can be given as follows:

$$\begin{matrix}{R}_{2 , 1} = {U}_{2 , 1} {\sum }_{2 , 1} {U}_{2 , 1}^{H} \\ {U}_{2 , 1} = [ {U}_{2 , 1}^{( 1 )} {U}_{2 , 1}^{( 0 )} ]\end{matrix} \qquad ( 5 )$$

### Where

$${U}_{2 , 1}^{( 1 )} ( {N}_{T X} \times r )$$

is the matrix collecting the eigen vectors having r non-zero eigenvalues, and

$${U}_{2 , 1}^{( 0 )} ( {N}_{T X} \times ( {N}_{T X} - r ) )$$

is the matrix collecting the eigen vectors having zero eigenvalues.

To satisfy the leakage constraint, |FH_{2,1}W_{2,2}|²→0, the precoder W_{2,2} should be identified from the null space of R₂ which is captured by

$${U}_{2}^{( 0 )} .$$

Accordingly, an effective channel,

$${\tilde{H}}_{2 , 2}^{eff}$$

can be identified as,

$${\tilde{H}}_{2 , 2}^{eff} = {\tilde{H}}_{2 , 2} {U}_{2 , 1}^{( 0 )}$$

Based on the effective channel in the null space, the precoder W_{2,2} can be determined as

$${W}_{2 , 2} = arg {max}_{p} Tr \{ {{P}^{H} ( {\tilde{H}}_{2 , 2} )}^{H} {\tilde{H}}_{2 , 2} P \} = arg {max}_{p} Tr \{ \{ {P}^{H} {U}_{2 , 1}^{( 0 )} \} {( {\tilde{H}}_{2 , 2}^{eff} )}^{H} ( {\tilde{H}}_{2 ,}^{eff} ) {\{ {U}_{2 , 1}^{( 0 )} \}}^{H} P \} \qquad ( 6 )$$

The solution to equation (6) can be determined by the first RI₂ (which is the rank of the transmission for non-JT UE 816) dominant eigen vectors of

$${\tilde{R}}_{2 , 2}^{eff}$$

where

$${\tilde{R}}_{2 , 2}^{eff}$$

is given as

$${\tilde{R}}_{2 , 2}^{eff} = {( {\tilde{H}}_{2 , 2}^{eff} )}^{H} {\tilde{H}}_{2 , 2}^{eff} = {\tilde{U}}_{2 , 2}^{eff} {\tilde{\sum }}_{2 , 2}^{eff} {\{ {\tilde{U}}_{2 , 2}^{eff} \}}^{H} \qquad ( 7 )$$

which can be established through the singular value decomposition of

$${( {\tilde{H}}_{2 , 2}^{eff} )}^{H} {\tilde{H}}_{2 , 2}^{eff} .$$

Then, precoder W_{2,2} can be determined based on the dominant eigen vector as:

$${W}_{2 , 2} = {\tilde{U}}_{2 , 2}^{eff} ( 1 : {RI}_{2} ) , Where \tilde{U} {}_{2 , 2}^{eff} = [ {\tilde{U}}_{2 , 2}^{eff} ( 1 : {RI}_{2} ) {\tilde{U}}_{2 , 2}^{eff , nul} ( {RI}_{2} + 1 : ( {N}_{T X} - r ) ) ] . \qquad ( 8 )$$

In some embodiments, an RB-level precoder W_{2,2} can be determined using an RB-level SRS channel. For example, in some embodiments, a precoder W_{2,2} can be derived for non-JT UE 816 for each RB, making use of the SRS channel H_{2,1}(n) obtained from the explicit signal used to collect CSI between JT UE 814 and BS 812, where n denotes the SRS channel estimated for the n-th RB. Note that an RB-level precoder W_{2,2} exploits the RB-level channel, while a wideband precoder W_{2,2} determined using a spatial covariance matrix and null space projection only uses the channel represented by the whole bandwidth, (i.e., the wideband channel). In some embodiments, to determine an RB-level precoder W_{2,2}, the eigen value decomposition of H_{2,1}(n) can be given as follows:

$${H}_{2 , 1} ( n ) = {u}_{2 , 1 ( n )} {\sum }_{2 , 1} ( n ) {U}_{2 , 1}^{H} ( n )$$

$${U}_{2 , 1}^{H} ( n ) = [ \begin{matrix}{U}_{2 , 1}^{( 1 )} ( n ) & {U}_{2 , 1}^{( 0 )} ( n )\end{matrix} ]$$

### Where

$${U}_{2 , 1}^{( 1 )} ( n )$$

is the matrix collecting eigen vectors having r non-zero eigenvalues, and

$${U}_{2 , 1}^{( 0 )} ( n )$$

is the matrix collecting the eigen vectors having zero eigenvalues.

To satisfy the leakage constraint, |FH_{2,1}W_{2,2}|²→0, the precoder W_{2,2}(n) should be identified from the null space of H_{2,1}(n) which is captured by

$${U}_{2 , 1}^{( 1 )} ( n ) .$$

Accordingly, an effective channel

$${\tilde{H}}_{2 , 2}^{eff}$$

can be identified as,

$${\tilde{H}}_{2 , 2}^{eff} ( n ) = {\tilde{H}}_{2 , 2} {U}_{2 , 1}^{( 0 )} ( n )$$

Based on the effective channel in the null space, the precoder W_{2,2} can be determined as

$${W}_{2 , 2} ( n ) = arg {max}_{p} Tr \{ \{ {P}^{H} {U}_{2 , 1}^{( 0 )} ( n ) \} {( {\tilde{H}}_{2 , 2}^{eff} ( n ) )}^{H} ( {\tilde{H}}_{2 , 2}^{eff} ( n ) ) {\{ {U}_{2 , 1}^{( 0 )} ( n ) \}}^{H} P \} \qquad ( 9 )$$

The solution to equation (9) can be determined by the first RI₂ (which is the rank of where the transmission for non-JT UE 816) dominant eigen vectors of

$${\tilde{R}}_{2 , 2}^{eff} ( n )$$

where

$${\tilde{R}}_{2 , 2}^{eff} ( n )$$

is given as

$${\tilde{R}}_{2 , 2}^{eff} ( n ) = {( {\tilde{H}}_{2 , 2}^{eff} ( n ) )}^{H} {\tilde{H}}_{2 , 2}^{eff} ( n ) = {\tilde{U}}_{2 , 2}^{eff} ( n ) {\tilde{\sum }}_{2 , 2}^{eff} ( n ) {\{ {\tilde{U}}_{2 , 2}^{eff} ( n ) \}}^{H} , \qquad ( 10 )$$

which can be established through the singular value decomposition of

$${( {\tilde{H}}_{2 , 2}^{eff} ( n ) )}^{H} {\tilde{H}}_{2 , 2}^{eff} ( n ) .$$

Then, W_{2,2}(n) can be determined based on the dominant eigen vector as:

$${W}_{2 , 2} ( n ) = {\tilde{U}}_{2 , 2}^{eff} ( n ) ( 1 : {RI}_{2} ) , \qquad ( 11 )$$

$$Where {\tilde{U}}_{2 , 2}^{eff} ( n ) = [ {\tilde{U}}_{2 , 2}^{eff} ( n ) ( 1 : {RI}_{2} ) {\tilde{U}}_{2 , 2}^{eff , nul} ( n ) ( {RI}_{2} + 1 : ( {N}_{TX} - r ) ) ] .$$

In in some embodiments, a wideband precoder W_{2,2} can be determined using subspace precoding. In these embodiments the spatial covariance of \tilde{H}_{2,2} can be determined as

\tilde{R}_{2,2}=(\tilde{H}_{2,2})^{H}\tilde{H}_{2,2}

Because \tilde{R}_{2,2} is Hermitian and (R_{2,1}+σ²I) is Hermitian, positive definite, by generalized eigenvalue decomposition, there is a non-singular matrix \tilde{T}_{2,2} such that

$${( {\tilde{T}}_{2 , 2} )}^{H} {\tilde{R}}_{2 , 2} {\tilde{T}}_{2 , 2} = {Λ}_{2 , 2}$$

$${( {\tilde{T}}_{2 , 2} )}^{H} ( {R}_{2} + {σ}^{2} I ) {\tilde{T}}_{2 , 2} = I ,$$

Where \tilde{T}_{2,2} can be derived using the Cholesky decomposition of

$$( {R}_{2} + {σ}^{2} I ) = {H}^{} . \qquad ( 12 )$$

Note that σ² is a parameter that can be configured. Using a larger σ², non-JT UE 816 will benefit from having a higher signal power, but meanwhile incurring a higher interference towards JT UE 814. On the other hand, using a smaller σ² will reduce the interference towards the JT UE 814, but at the cost of losing some signal power to non-JT UE 816.

Subsequently, from the eigen decomposition of the symmetric matrix, ( [symbol] ⁻¹)^{H}\tilde{R}_{2,2} [symbol] ⁻¹, we have

$${( {- 1}^{} )}^{H} {\tilde{R}}_{2 , 2} {- 1}^{} = {ΨΛ}_{2 , 2} {Ψ}^{H} \qquad ( 13 )$$

$${{Ψ}^{H} ( {- 1}^{} )}^{H} {\tilde{R}}_{2 , 2} {- 1}^{} Ψ = {Λ}_{2 , 2} .$$

Therefore,

$${\tilde{T}}_{2 , 2} = {- 1}^{} Ψ \qquad ( 14 )$$

Assuming entries in Λ_{2,2} are in ascending order, the first RI₂ columns of \tilde{T}_{2,2} are used as W_{2,2}.

In some embodiments, precoder W_{2,2} may not be updated in each time slot. For example, a wideband precoder W_{2,2} determined using a spatial covariance matrix and null space projection as described above depends on 2^{nd} order statistics of JT UE 814, and therefore may not benefit from frequent updating. In some embodiments, if certain conditions are satisfied, a previously determined precoder W̅_{2,2} can be applied in the current time slot. For example, the previously determined precoder W̅_{2,2} may be used if the channel is deemed to be relatively stable. In these embodiments, a precoder calculation for precoder W_{2,2} as described herein can be skipped.

In some embodiments, when the spatial covariance matrix of the SRS channel

$${R}_{2 , 1} = \frac{1}{{N}_{RB}} {\sum }_{j = 1}^{{N}_{RB}} {H}_{2 , 1}^{H} ( j ) {H}_{2 , 1} ( j )$$

does not change significantly (referred to herein as “Condition 1”), the precoder calculation precoder W_{2,2} can be skipped. In some embodiments, if d{R₂, R̅₂}≤β_{cov} (where R̅₂ denotes the spatial covariance matrix observed previously) and the reported PMI

$${W}_{CB}^{H}$$

by non-JT UE 816 is not updated, where d{X₁, X₂} is a distance metric to find similarity between X₁, X₂ matrices, and β_{cov} is a predefined threshold, the precoder calculation for precoder W_{2,2} is not invoked.

In some embodiments, when the SRS channel H_{2,1} is updated, if the expected interference towards JT UE 814 with the previously determined precoder (i.e., W̅_{2,2}) for non-JT UE 816 can effectively mitigate the interference already (referred to herein as “Condition 2”), i.e., |H_{2,1}W̅_{2,2}|²≤β_{inf}, where β_{inf} is a predefined threshold, the precoder calculation for precoder W_{2,2} is not invoked.

In some embodiments, determination of a wideband precoder W_{2,2} using subspace precoding can be summarized according to the following algorithm:

If non-JT UE traffic available:
Input:

$${W}_{CB}^{H}$$

Type-I PMI of non-JT UE; H₂—RB-level SRS channel of JT UE
   Calculate R₂ from H₂
   If d{R₂, R̅₂}≤β and

$${W}_{CB}^{H}$$

is not updated (where d{X₁, X₂} is a distance metric to find similarity between X₁, X₂ matrices)
   \tilde{W}_{non-JT} is not updated and same as what is calculated previously
else

$$Derive {U}_{2}^{( 0 )} \qquad from equation ( 5 )$$

$$Derive {\tilde{U}}_{non - JT}^{eff} ( 1 : {RI}_{Non - JT} ) \qquad from equation ( 7 )$$

$${\tilde{W}}_{non - JT} = {U}_{2}^{( 0 )} {\tilde{U}}_{non - JT}^{eff} ( 1 : {RI}_{Non - JT} )$$

Output: \tilde{W}_{non-JT}
   If non-JT UE traffic not available:
Input: H₂—RB-level SRS channel of JT UE
   Derive zero-forcing (ZF) precoders W₂ from H₂ for JT UE
Output: W₂

In some embodiments, determination of an RB-level precoder W_{2,2} using an RB-level SRS channel can be summarized according to the following algorithm:

If non-JT UE traffic available:
Input:

$${W}_{CB}^{H}$$

Type-I PMI of non-JT UE, H₂—RB-level SRS channel of JT UE
   For n=1: N_{RB}; loop over each RB

$$Derive {V}_{2}^{( 0 )} ( n ) from {H}_{2} ( n ) = {U}_{2} {{\sum }_{2} [ {V}_{2}^{( 1 )} {V}_{2}^{( 0 )} ]}^{H}$$

$$Identify {W}_{proj} ( n ) = {W}_{CB}^{H} {V}_{2}^{( 0 )} ( n )$$

$$Perform SVD , {W}_{proj} = {U}_{proj} {{\sum }_{proj} [ {V}_{proj}^{( 1 )} {V}_{proj}^{( 0 )} ]}^{H}$$

$${\tilde{W}}_{non - JT} ( n ) = {V}_{2}^{( 0 )} ( n ) {V}_{proj}^{( 1 )} ( n )$$

Output: \tilde{W}_{non-JT}
   If non-JT UE traffic not available:
Input: H₂—RB-level SRS channel of JT UE
   Derive ZF precoders W₂ from H₂ for JT UE
Output: W₂

In some embodiments, determination of a wideband precoder W_{2,2} using subspace precoding can be summarized according to the following algorithm:

If non-JT UE traffic available:
Input:

$${W}_{CB}^{H}$$

Type-I PMI of non-JT UE, H₂—RB-level SRS channel of JT UE
   Determine the spatial covariance of \tilde{H}₂ as \tilde{R}_{2,2}=(\tilde{H}_{2,2})^{H}\tilde{H}_{2,2}, where

$${\tilde{H}}_{2 , 2} = {W}_{CB}^{H}$$

Derive [symbol] using the Cholesky decomposition

$${R}_{2 , 1} = \frac{1}{{N}_{RB}} {\sum }_{j = 1}^{{N}_{RB}} {H}_{2}^{H} ( j ) {H}_{2} ( j ) and ( {R}_{2 , 1} + {σ}^{2} I ) = {H}^{} .$$

Eigen decomposition of ( [symbol] ⁻¹)^{H}\tilde{R}_{2,2} [symbol] ⁻¹ as ( [symbol] ⁻¹)^{H}\tilde{R}_{2,2} [symbol] ⁻¹=ΨΛ_{2,2}Ψ^{H} and Ψ^{H}( [symbol] ⁻¹)^{H}\tilde{R}_{2,2} [symbol] ⁻¹Ψ=Λ_{2,2}
Obtain \tilde{T}_{2,2}= [symbol] ⁻¹Ψ
Take the first RI_{non-JT} columns of \tilde{T}_{2,2} are used as \tilde{W}_{non-JT}
Output: \tilde{W}_{non-JT}
   If non-JT UE traffic not available:
Input: H₂—RB-level SRS channel of JT UE
   Derive ZF precoders W₂ from H₂ for JT UE
Output: W₂

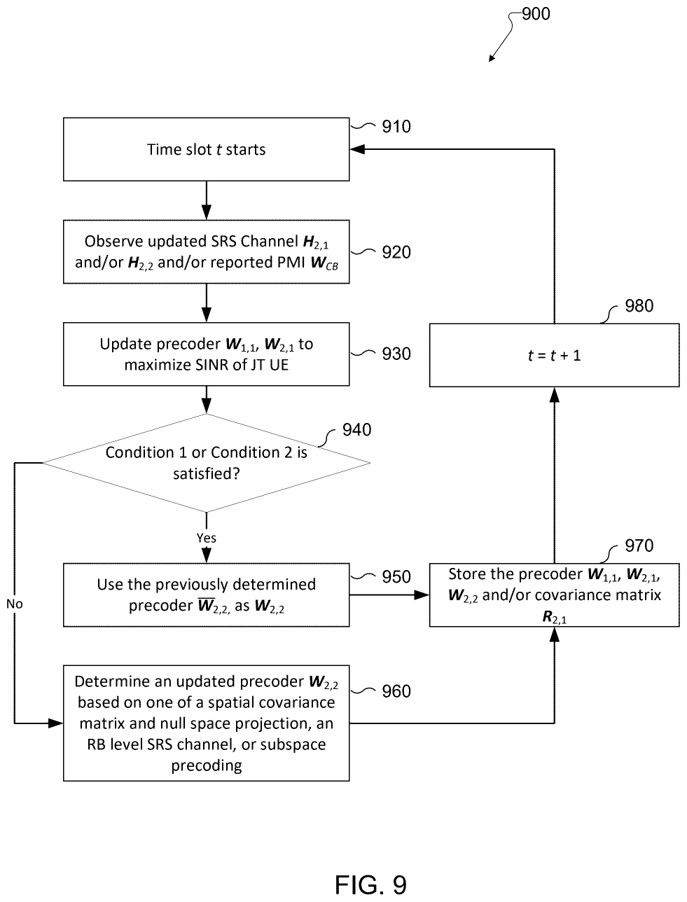

FIG. 9 illustrates an example method 900 for precoder determination for joint transmission according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments for precoder determination for joint transmission could be used without departing from the scope of this disclosure.

In the example of FIG. 9, method 900 begins at step 910. At step 910, a time slot “t” starts for a distributed MIMO system (for example, the distributed MIMO system illustrated in FIG. 8).

At step 920, the distributed MIMO system observes updated SRS channel H_{2,1} and/or H_{2,2} (for instance, from a Type I UE such as JT UE 814) and/or reported PMI W_{CB} (for instance, from a Type II UE such as non-JT UE 816). For example, a first TRP (such as BS 810) may observe updated SRS Channel H_{2,1}, and a second TRP (such as BS 812) may observe updated SRS Channel H_{2,2} and reported PMI W_{CB}.

At step 930, the distributed MIMO system updates precoders W_{1,1}, W_{2,1} for a JT UE (for instance, JT UE 814) associated with the updated SRS Channel H_{2,1} and/or H_{2,2} to maximize the SINR of the JT UE.

At step 940, the distributed MIMO system determines whether Condition 1 (i.e., the spatial covariance matrix of the SRS channel

$${R}_{2 , 1} = \frac{1}{{N}_{RB}} {\sum }_{j = 1}^{{N}_{RB}} {H}_{2 , 1}^{H} ( j ) {H}_{2 , 1} ( j )$$

does not change significantly) and/or Condition 2 (i.e., the expected interference towards the JT UE with a previously determined precoder W̅_{2,2} can effectively mitigate the interference already) as described herein is satisfied. If either condition is satisfied, method 900 proceeds to step 950. Otherwise, if neither condition is satisfied, method 900 proceeds to step 960.

At step 950, the distributed MIMO system uses the previously determined precoder W̅_{2,2} as W_{2,2}.

At step 960, the distributed MIMO system determines an updated precoder W_{2,2}. In some embodiments, the updated precoder may be determined based on a spatial covariance matrix and null space projection. In some embodiments, the updated precoder may be determined based on an RB level SRS channel. In some embodiments, the updated precoder may be determined based on subspace precoding.

At step 970, the distributed MIMO system stores the precoders W_{1,1}, W_{2,1}, W_{2,2} and/or covariance matrix R_{2,1}. In some embodiments, these precoders may be used by the distributed MIMO system to transmit traffic to the JT UE by the first TRP and the second TRP during time slot t. In some embodiments, these precoders may be used by the first TRP to transmit traffic to the JT UE, and may be used by the second TRP to transmit traffic to a non-JT UE (for instance, non-JT UE 416) during time slot t.

At step 980, the time slot t ends, and the next time slot t+1 begins, returning method 900 to step 910.

Although FIG. 9 illustrates one example method 900 for precoder determination for joint transmission, various changes may be made to FIG. 9. For example, while shown as a series of steps, various steps in FIG. 9 could overlap, occur in parallel, occur in a different order, occur any number of times, be omitted, or replaced by other steps.

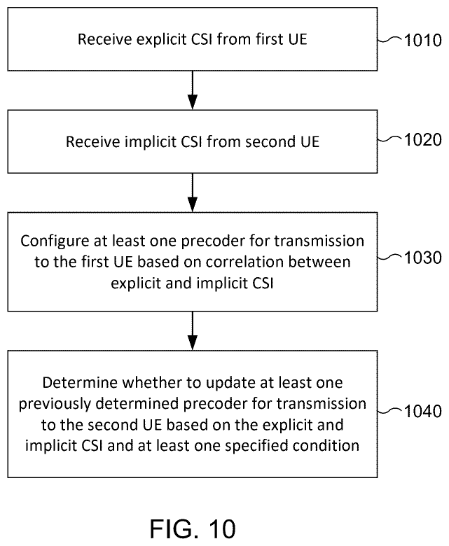

FIG. 10 illustrates an example method 1000 for operating a base station according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method for operating a base station could be used without departing from the scope of this disclosure.

In the example of FIG. 10, method 100 begins at step 1010. At step 1010, a BS (such as BS 812 of FIG. 8) receives explicit CSI (such as an SRS) from a first UE (such as JT UE 814 of FIG. 8).

At step 1020, the BS receives implicit CSI (such as a PMI report) from a second UE (such as non-JT UE 816 of FIG. 8).

At step 1030, the BS configures, based on at least one correlation between the explicit CSI signaling and the implicit CSI signaling, at least one precoder for a transmission to the first UE. The precoder is configured to mitigate interference between the first UE and the second UE, and preserve a target signal power receivable by at least one of the first UE and the second UE.

At step 1040, the BS determines, based on the explicit CSI signaling, the implicit CSI signaling, and at least one specified condition (such as Condition 1 or Condition 2 as described herein) whether to update at least one previously determined precoder for transmission to the second UE.

In some embodiments, the at least one specified condition may be associated with at least one of a spatial covariance matrix, and an expected interference toward a particular UE type. In some embodiments, the expected interference may be an interference from a UE type for which implicit signals are used to collect CSI toward a UE type for which explicit signals are used to collect CSI.

In some embodiments, based on a determination not to update the at least one previously determined precoder for transmission to the second UE, the BS may transmit a transmission for the second UE based on the at least one previously determined precoder for transmission to the second UE.

In some embodiments, based on a determination to update the at least one previously determined precoder for transmission to the second UE, the BS may determine at least one updated precoder for transmission to the second UE, and transmit a transmission for the second UE based on the at least one updated precoder for transmission to the second UE.

In some embodiments, the at least one updated precoder for transmission to the second UE may determined based on one of a spatial covariance matrix and null space projection, a resource block level SRS channel, or a subspace precoding.

Although FIG. 10 illustrates one example method for 1000 for operating a base station, various changes may be made to FIG. 10. For example, while shown as a series of steps, various steps in FIG. 10 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A base station (BS) comprising:
a transceiver configured to:
receive, from a first user equipment (UE) in a distributed multi-input multi-output (MIMO) system, an explicit channel state information (CSI) signaling; and
receive, from a second UE in the distributed MIMO system, an implicit CSI signaling; and
a processor operably coupled to the transceiver, the processor configured to:
configure, based on at least one correlation between the explicit CSI signaling and the implicit CSI signaling, at least one precoder for a transmission to the first UE, wherein the at least one precoder for transmission to the first UE is configured to:
mitigate interference between the first UE and the second UE; and
preserve a target signal power receivable by at least one of the first UE and the second UE; and
determine, based on the explicit CSI signaling, the implicit CSI signaling, and at least one specified condition whether to update at least one previously determined precoder for transmission to the second UE.

2. The BS of claim 1, wherein the processor is further configured to, based on a determination not to update the at least one previously determined precoder for transmission to the second UE, cause the transceiver to transmit a transmission for the second UE based on the at least one previously determined precoder for transmission to the second UE.

3. The BS of claim 1, wherein the processor is further configured to, based on a determination to update the at least one previously determined precoder for transmission to the second UE:
determine at least one updated precoder for transmission to the second UE; and
transmit a transmission for the second UE based on the at least one updated precoder for transmission to the second UE.

4. The BS of claim 3, wherein the at least one updated precoder for transmission to the second UE is determined based on one of:
a spatial covariance matrix and null space projection;
a resource block (RB) level SRS channel; or
subspace precoding.

5. The BS of claim 1, wherein the at least one specified condition is associated with at least one of:
a spatial covariance matrix; and
an expected interference toward a particular UE type.

6. The BS of claim 5, wherein the expected interference is interference from a UE type for which implicit signals are used to collect CSI toward a UE type for which explicit signals are used to collect CSI.

7. The BS of claim 1, wherein:
the first UE is a joint transmission (JT) UE;
the second UE is a non-joint transmission (non-JT) UE;
the explicit CSI signaling is a sounding reference signal (SRS); and
the implicit CSI signaling is a reported precoding matrix indicator (PMI).

8. A method of operating a base station (BS), the method comprising:
receiving, from a first user equipment (UE) in a distributed multi-input multi-output (MIMO) system, an explicit channel state information (CSI) signaling;
receiving, from a second UE in the distributed MIMO system, an implicit CSI signaling;
configuring, based on at least one correlation between the explicit CSI signaling and the implicit CSI signaling, at least one precoder for a transmission to the first UE, wherein the at least one precoder for transmission to the first UE is configured to:
mitigate interference between the first UE and the second UE; and
preserve a target signal power receivable by at least one of the first UE and the second UE; and
determining, based on the explicit CSI signaling, the implicit CSI signaling, and at least one specified condition whether to update at least one previously determined precoder for transmission to the second UE.

9. The method of claim 8, further comprising, based on a determination not to update the at least one previously determined precoder for transmission to the second UE, transmitting a transmission for the second UE based on the at least one previously determined precoder for transmission to the second UE.

10. The method of claim 8, further comprising, based on a determination to update the at least one previously determined precoder for transmission to the second UE:
determining at least one updated precoder for transmission to the second UE; and
transmitting a transmission for the second UE based on the at least one updated precoder for transmission to the second UE.

11. The method of claim 10, wherein the at least one updated precoder for transmission to the second UE is determined based on one of:
a spatial covariance matrix and null space projection;
a resource block (RB) level SRS channel; or
subspace precoding.

12. The method of claim 8, wherein the at least one specified condition is associated with at least one of:
a spatial covariance matrix; and
an expected interference toward a particular UE type.

13. The method of claim 12, wherein the expected interference is interference from a UE type for which implicit signals are used to collect CSI toward a UE type for which explicit signals are used to collect CSI.

14. The method of claim 8, wherein:
the first UE is a joint transmission (JT) UE;
the second UE is a non-joint transmission (non-JT) UE;
the explicit CSI signaling is a sounding reference signal (SRS); and
the implicit CSI signaling is a reported precoding matrix indicator (PMI).

15. A non-transitory computer readable medium embodying a computer program comprising program code that, when executed by a processor of a device, causes the device to:
receive, from a first user equipment (UE) in a distributed multi-input multi-output (MIMO) system, an explicit channel state information (CSI) signaling;
receive, from a second UE in the distributed MIMO system, an implicit CSI signaling;
configure, based on at least one correlation between the explicit CSI signaling and the implicit CSI signaling, at least one precoder for a transmission to the first UE, wherein the at least one precoder for transmission to the first UE is configured to:
mitigate interference between the first UE and the second UE; and
preserve a target signal power receivable by at least one of the first UE and the second UE; and
determine, based on the explicit CSI signaling, the implicit CSI signaling, and at least one specified condition whether to update at least one previously determined precoder for transmission to the second UE.

16. The non-transitory computer readable medium of claim 15, wherein the computer program includes program code, that when executed by the processor of the device, causes the device to, based on a determination not to update the at least one previously determined precoder for transmission to the second UE, transmit a transmission for the second UE based on the at least one previously determined precoder for transmission to the second UE.

17. The non-transitory computer readable medium of claim 15, wherein the computer program includes program code, that when executed by the processor of the device, causes the device to:
determine at least one updated precoder for transmission to the second UE; and
transmit a transmission for the second UE based on the at least one updated precoder for transmission to the second UE.

18. The non-transitory computer readable medium of claim 17, wherein the at least one updated precoder for transmission to the second UE is determined based on one of:
a spatial covariance matrix and null space projection;
a resource block (RB) level SRS channel; or
subspace precoding.

19. The non-transitory computer readable medium of claim 15, wherein the at least one specified condition is associated with at least one of:
a spatial covariance matrix; and
an expected interference from a UE type for which implicit signals are used to collect CSI toward a UE type for which explicit signals are used to collect CSI.

20. The non-transitory computer readable medium of claim 15, wherein:
the first UE is a joint transmission (JT) UE;
the second UE is a non-joint transmission (non-JT) UE;
the explicit CSI signaling is a sounding reference signal (SRS); and
the implicit CSI signaling is a reported precoding matrix indicator (PMI).
